(19) United States
(12) Patent Application Publication
(10) Pub. No.: US 2022/0355215 A1
(43) Pub. Date: Nov. 10, 2022

(54) DECORATIVE PELLET AND METHOD

(71) Applicant: JINAN IDOON ANIMATION TECHNOLOGY CO., LTD, Jinan (CN)

(72) Inventor: Liangchao GUAN, Jinan (CN)

(21) Appl. No.: 16/758,330

(22) PCT Filed: Jan. 24, 2020
(86) PCT No.: PCT/CN2020/074044

§ 371 Date: Apr. 22, 2020

(30) Foreign Application Priority Data
Jan. 22, 2020 (CN) 202010075217.4

(51) Int. Cl. A63H 3/36; B44C 5/00

(52) U.S. Cl. CPC A63H 3/36; B44C 5/00

(57) ABSTRACT

The present invention relates to a kind of decorative pellet and the play method thereof, which can be mounted on the outer surface of objects such as crafts or toys and used to decorate/cover the appearance/shape of the objects. The pellet includes fiber bundle with one end in a free state and another end in an aggregated state, and an end cap which is at the aggregated end of the fiber bundle. The aggregated end of the fiber bundle matches the end of the end cap. The fiber bundle contains a plurality of strands that are assembled at one end to be a joint segment and this joint segment is inserted into the endhole of the end cap. The surface of the strand is smooth and/or rough. The free end of the end cap can be plugged into the outside of the object and establish a tight assembly relationship with the object. When the decorative pellets are used as a decorative part to decorate crafts or toys, they have the advantages of easy installation, replacement/change, and easy optimization, adjustment or resetting of the object appearance scheme. Using the decorative pellets can create new structures for plush toys or items.

### TECHNICAL FIELD

The present patent relates to a pellet used to decorate an object, especially to decorate a craft, a doll, etc., and a method for applying such pellets to an object.

### BACKGROUND

In the field of crafts and toys, the need for a certain degree of decoration on the surface is often involved. In the existing decorative methods, the most common method is to paste the decorative components onto the object. The main disadvantages are that decorative components can not or not easy to be replaced, and the accuracy of the operation requirement is higher, otherwise it will cause extremely poor decorative effect. In addition, when the decorative components are fixed on the surface of a curved or uneven object by pasting, the decorative components are easily dropped from the surface of the object due to the pull-down force or external force formed by its own gravity, and the connection is not secure. Moreover, when the decoration components containing hair, silk thread, other slender and soft ornaments are installed on the surface of the object by sticking, there is a problem that the hair and silk thread are partly adhered to the glue, and the installation operation is very inconvenient. In view of this, it would be beneficial to create a new decorative structure that has the advantage of being easy to install and replace when used to decorate/cover the outer surface of objects.

### SUMMARY

The decorative pellets provided in this patent have the advantages of being easy to install, replace, change, and easy to optimize, adjust or reconstruct the object appearance scheme when they are used as components of decorative crafts and toys.

The patent relates to a kind of decorative pellet that can be mounted on the outer surface of a craft, a toy, such as a doll, a car model, an airplane model, a building model, etc., to decorate/cover the appearance/shape of the aforementioned object.

The decorative pellet has the characteristics that the fiber bundle with one end in a free state and another end in an aggregated state and an end cap which is at the end of the fiber bundle in an aggregated state. The aggregated end of the fiber bundle matches the end of the end cap.

The fiber bundle contains a plurality of strands that are assembled at one end to be a joint segment and this joint segment is inserted into the endhole of the end cap.

The surface of the strand is smooth and/or rough. The free end of the end cap can be plugged into the outside of the object and establish a tight assembly relationship with the object.

The strands contain single or multiple yarns, and the number of yarns contained in different strands is not completely consistent. The yarn is woven with one or more of natural fibers, synthetic fibers, and artificial fibers.

In actual production, the manufacturing method of the joint segment formed by aggregating multiple strands of the fiber bundle at one end is achieved by glue or resin bonding, or by thermoplastic extrusion, or by a weaving process, or by other production process.

Further, the side wall of the end cap is provided with a convex ring or a plurality of convex points distributed in a circle around the side wall of the end cap. The position of the convex ring or convex points is relatively close to the free end face of the end cap in the axial direction.

An object used to bear the decorative pellet is provided with a hole/slot structure so as to match the end cap, and the convex ring or convex point will compress the inner wall of the hole/slot structure when the end cap is inserted into the hole/slot structure. Therefore, the decorative pellets or end caps establish a tight assembly relationship with the object, and then decorate or cover the outside of the object to different degrees.

Further, the shape of the end cap is cylindrical or prismatic or conical.

The end cap contains part 1 and part 2, and part 1 and part 2 are semi-cylindrical tubes installed oppositely, and the formed tube holes are cylindrical holes with the same inner diameter or conical holes that gradually become smaller from outside to inside.

On the side wall of part 1 and on both sides of the pipe notch, opposite clamping slots are arranged. Correspondingly, on the side wall of part 2 and on both sides of the pipe notch, locking arms corresponding to the clamping slots are arranged.

When the part 1 and part 2 are oppositely installed together, the free end of the locking arm is placed into the clamping slot, forming a clasping tension between the part 1 and the part 2, so that the opposite side of the part 1 and the part 2 is pressed together. The convex ring or a plurality of convex points are divided into two parts and arranged on the wall surfaces of part 1 and part 2.

Further, the end cap comprises component 1, component 2 and component 3, wherein component 1 is a screw ring, component 2 is a sleeve, and component 3 is a cylinder, and the joint segment of fiber bundle is arranged in the cylinder cavity of component 3. The wall thickness of component 3 is less than that of component 2.

The cylinder wall of the component 3 is provided with a strip groove extending from the port to the other end, and the number of the strip groove is multiple and distributed around the cylinder wall. The outer wall of the other end of the component 3 is provided with an external thread section matching component 1. The component 2 is sleeved at the outside of component 3.

The axial length of component 3 is greater than the axial length of component 2. When the component 1 is gradually screwed on the external thread section of component 3, the component 1 can push the component 2 to move towards the cylinder cavity port direction of component 3. During this period, the inner wall of component 2 will squeeze the cylinder wall of the component 3 and gradually gather inward in the radial direction. Eventually, the joint segment of fiber bundle will be firmly controlled in the cylinder cavity of component 3.

Further, the convex points with curved end surface are distributed on the outer wall of the cylinder cavity of the component 3. When the component 2 is sleeved on the outside of the component 3, and the inner wall of the component 2 is in contact with the end surface of convex point on the external wall of the component 3.

Further, the cylinder wall of component 3 is provided with strip bosses, the number of which is multiple and alternately distributed around the cylinder wall. The strip boss extends along the axial direction and the side of facing inner wall of component 2 is a wedge surface, which gradually approaches the outer wall of the cylinder cavity of component 3 in the direction of free end from the cavity port of component 3.

Further, the cavity port of component 3 is provided with a flange extending radially inward, and the reason for the flange is formed by a circle of arc listrium arranged in one circle around the inner wall of component 3.

A method of using decorative pellets, which is the process of creating a plush toy with a plurality of decorative pellets having the characteristics defined above. The implementation of the method also requires the provision of a fixed shape substrate with multiple holes/slots distributed on the surface of it. Characterized by: the end cap of the decorative pellet is aligned with the hole/slot on the substrate and all the end caps are inserted into the hole/slot of the substrate. After the holes/slots on the substrate are all inserted by the decorative pellets, strongly press or distribute outward the fiber bundles of the decorative pellets so that the strands of the fiber bundles unfold and the surface of the substrate is covered to form a toy with a plush appearance.

Further improvement based on the above method, wherein the color of fiber bundles for most of decorative pellets is same, the color of fiber bundles for remaining decorative pellets can be different from the color of fiber bundles for most of decorative pellets, and the color of fiber bundles for remaining decorative pellets is the same or is divided into a variety of color;

The holes/slots on the substrate are marked with serial numbers. According to the numbered range of holes/slots, the installation positions of decorative pellets with different colors are arranged regularly to form toys with multi-color combined plush surface and/or a certain pattern on the plush surface.

### BRIEF DESCRIPTION OF THE DRAWINGS

FIG. 1 shows a three-dimensional diagram of an embodiment of decorative pellet.

FIG. 2 shows the overall structure diagram of the fiber bundle.

FIG. 3 shows a schematic diagram of the transverse section of the end cap under certain embodiments.

FIG. 4 shows the wall structure diagram of the inner wall of the end cap after the side wall is flattened.

FIG. 5 highlights a schematic diagram of a longitudinal section of the end cap in an embodiment.

FIG. 6 shows the schematic diagram of A-A transverse section in FIG. 5.

FIG. 7 shows the matching state of the decorative pellets with the cake-shaped decorated object (incomplete decoration).

FIG. 8 is a sectional view of the usage scenario in FIG. 7 (showing the connection structure between the end cap and the decorated object).

FIG. 9 shows a schematic diagram of the matching of decorative pellets and dolls (unicorn).

FIG. 10 shows a sample product diagram formed after decorating different objects (including dolls) with decorative pellets

### FIGURE

100 Substrate 1, 1001 hole 1; 200 Substrate 2, 2001 hole 2;

10 fiber bundle, 10A free end, 10B joint segment, 101 strand, 20 end cap, 201 part 1, 202 part 2, 203 component 1, 204 component 2, 205 component 3, 30 convex ring.

1 clamping slot, 2 locking arm, 3 positioning block, 4 rib, 5 strip groove, 6 flange.

### DETAILED DESCRIPTION OF THE EMBODIMENTS

The structures, proportions, sizes, etc. shown in the drawings of the instruction are only used to cooperate with the content disclosed in the instruction for those familiar with this technology to understand and read. They are not the restrictive conditions of the implementation by present invention, so they do not have the technical substance significance. Without affecting the efficacy and the purpose that can be achieved by the present invention, any structural modification or change in proportional relationship, or adjustment in size should still fall within the scope of technical content disclosed in the present invention. At the same time, the terms such as “upper”, “lower”, “front”, “rear”, “middle” etc. cited in the present instruction are only for the convenience of description and are not intended to limit the scope of the present invention. The change or adjustment of the relative relationship without substantial changes in the technical content shall be regarded as the scope in which the present invention can be implemented.

The patent relates to a kind of decorative pellet that can be mounted on the outer surface of a craft, a toy, such as a doll, a car model, an airplane model, a building model, etc., to decorate/cover the appearance/shape of the aforementioned object. Using this kind of decorative pellet to create a new type of plush toy or stuffed item.

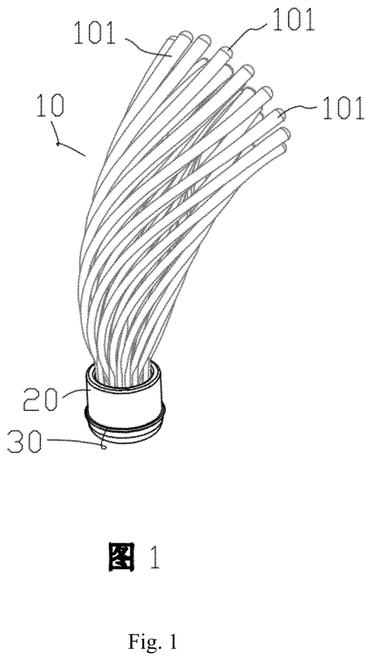

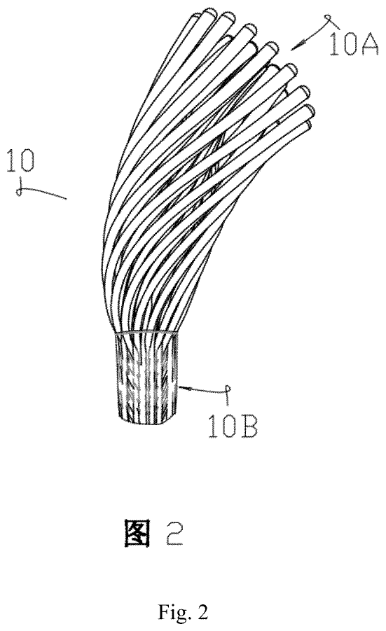

As shown in FIG. 1 and FIG. 2, the involved decorative pellet includes fiber bundle 10 and end cap 20. The free end 10A of the fiber bundle 10 is in a free state, the other end is in an aggregated state to form a joint segment 10B. The joint segment 10B of the fiber bundle 10 is plugged into the hole cavity of the end cap 20 so that the fiber bundle 10 and the end cap 20 are connected into a whole. In order to ensure that the fiber bundle 10 is firmly connected to the end cap 20, a tight assembly is adopted between the joint segment 10B and the hole cavity of the end cap 20.

The fiber bundle 10 includes a plurality of strands 101, and the plurality of strands 101 are gathered at an end near the end cap 20 to form the joint segment 10B. In actual production, the manufacturing method of the joint formed by aggregating multiple strands of the fiber bundle at one end is achieved by glue or resin bonding, or by thermoplastic extrusion, or by a weaving process, or by other production process.

The strand contains single or multiple yarns, and the number of yarns contained in different strands may not be exactly the same. The yarn can be woven from natural fibers, such as cotton and linen from plant fibers, wool and silk from animal fibers, and synthetic fibers, such as chinlon, tetroon also known as nylon, acrylic or polyester, polyethylene, etc ., also can be woven from artificial fibers, such as artificial cotton, or rayon. Of course, it can also be woven from blended fibers. Some of the multiple fiber bundles may use the same material, and the other fiber bundles use another material or several materials.

The strands contained in the fiber bundle may be in a single color or multiple colors. Multiple fiber bundles may contain fiber bundles of one color or multiple colors.

In most cases, the lengths of the plurality of strands constituting a certain fiber bundle are approximately same, and the lengths of the strands in different fiber bundles may be approximately same or different. The thickness of the strands in the same fiber bundle may not be same.

The outer surface of the strand may be generally smooth or rough.

In most cases, the strands with a rough outer surface are formed by interweaving/knitting multiple fiber filaments (yarns). The rough surface is formed by the natural branching of the fiber filaments, so the outer surface of each strand will have many uneven fine bifurcations. If the fiber bundles are combed in one direction so that all the strands are closer to the central axis of the fiber bundle, the outer fine bifurcations of the strands will stick to each other, which can eventually make multiple strands to be connected together in a columnar shape. After that, if the relatively discrete ends of the strands of the fiber bundle are pressed, each strand of the fiber bundle will be separated from each other.

As a few cases, the rough surface of a strand having a rough outer surface is formed by the weaving or manufacturing process of the strand. At this time, the branching structure constituting the rough surface is relatively thick. In addition, the actual produced fiber bundle is made of strands that may be straight, bent or rolled.

The strands of the fiber bundle can be soft or can be shaped.

When the decorative pellets are used to make a wig, the strands contained in the fiber bundles thereof should be elongated.

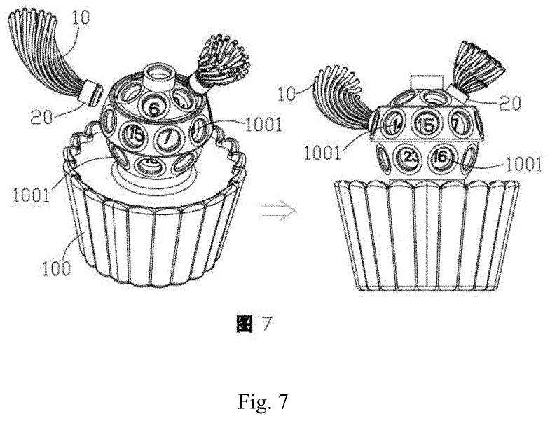

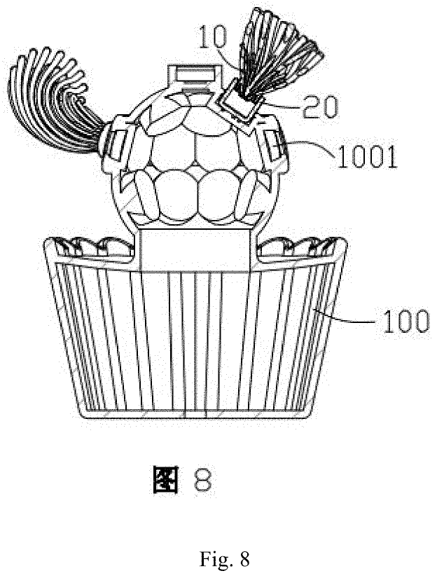

When in use, the free end of the end cap 20 should be plugged into the outside of the object that needs to be decorated/covered (substrate 1 100 and substrate 2 200 as shown in FIG. 7 to FIG. 9), and establish a tight assembly relationship with the object. The effect of tight assembly relationships is to ensured that can be removed from objects only when the unloading force applied to them is large enough.

The hole cavity provided on the end cap 20 for receiving the joint section 10B of fiber bundle 10 may be set as a sink hole or a through hole. At this time, a hole/slot structure can be provided on the object that needs to be decorated/covered, and the end cap 20 of the decorative pellets can be inserted into the hole/slot structure, and the matching relationship between the end cap 20 and the hole/slot structure should be in tight assembly relationship as shown in FIG. 7 to 9. It is also possible to provide a boss structure on the object that needs to be decorated/covered. The free end of the end cap of the decorative pellets can be inserted on the boss structure, and the cooperation between the end cap and the boss structure also adopts a tight fitting relationship.

The hole/slot structure or boss structure arranged on the object can be distributed on component of the external surface of the object, or basically distributed on the entire external surface of the object. Therefore, decorative pellets can be used to partially decorate objects, and they can also be used to cover the outer surface of an object to change the appearance of an object in certain aspects, such as texture, shape, style, and color configuration etc. so as to make the appearance of the object more visually beautiful and/or tactilely comfortable.

As shown in FIG. 1 and FIG. 2, a convex ring 30 is provided on a side wall of the end cap 20, and the position of the convex ring is relatively close to the free end surface of the end cap 20 in the axial direction. In order to facilitate the assembly of the decorative pellets and the object, the end surface of the convex ring 30 should be a arc surface. The convex ring 30 may be a circle as shown in the figure, or may be a plurality of convex points distributed alternately around one side wall of the end cap 20.

In one embodiment, when the hole cavity for assembling the fiber bundle on the end cap is a through hole, convex ring or convex points can also be provided on the wall of the hole.

In another embodiment, the end cap may be at least partially set as a conical section, and the small end of the conical section is the free end of the end cap. When the hole cavity for assembling the fiber bundle on the end cap is a through hole, the conical section may be provided at one end of the through hole or at the outside of the end cap and the through hole at the same time.

The above-mentioned convex ring or convex point structure, or conical section structure is used to enable the end cap to establish a reliable tight assembly relationship with the object, and it can relatively reduce the difficulty of assembly at the same time.

In order to realize that the fiber bundle is conveniently installed into the end cap, and simultaneously ensure that the fiber bundle cannot be easily separated from the end cap after being installed together, the end cap may be designed as follows in some specific embodiments.

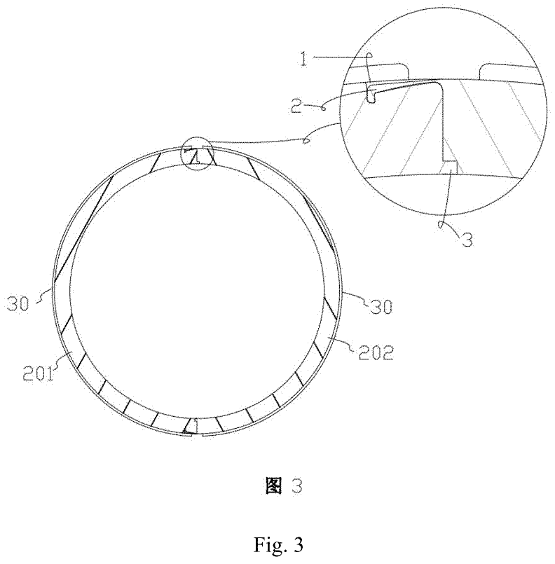

As shown in FIG. 3, the end cap contains part 1 and part 2, and part 1 and part 2 are semi-cylindrical tubes installed oppositely. The hole cavity formed by the part 1 201 and the part 2 202 facing each other to receive the fiber bundle 10 joint segment 10B is a cylindrical hole (column-shaped hole).

In one embodiment, the hole cavity formed after the part 1 201 and the part 2 202 are opposite to each other may also be a conical hole whose inner diameter gradually decreases from the port inward.

Opposite clamping slots 1 are provided on the side wall of the part 1 201 and on both sides of the (semi-cylindrical) pipe notch. On the side wall of part 2 202 and on both sides of the (semi-cylindrical) pipe notch, locking arms 2 corresponding to the clamping slot 1 is provided.

When the part 1 and part 2 are oppositely installed together, the free end of the locking arm is placed into the clamping slot, forming a clasping tension between the part 1 and the part 2, so that the opposite sides of part 1 and part 2 are pressed together. The majority of the clasping force comes from the plastic deformation of the locking arm 2. In order to ensure the clasping firmness and the formation of the cohesion force, it is necessary to design the surface of the locking block at the end of the locking arm and the slot surface of the clamping slot 1. Therefore, after the surface of locking block contacts the surface of the clamping slot, the surface of slot will push the locking block, and the arm of locking arm 2 will be affected by the tensile force and generate the appropriate degree of plastic deformation.

As shown in the figure, the side wall of the part 1 201 is provided with at least one set of opposite clamping slots 1, and correspondingly, the side wall of the part 2 202 is provided with at least one set of opposite locking arms 2. That is, the number of groups of the clamping slots 1 provided on the side wall of the part 1 201 is as many as the number of groups of the locking arms 2 provided on the side wall of the part 2 202 and one-to-one correspondence.

As for the specific need to set several sets of clamping slots and locking arms, it needs to be determined according to the axial length of the end cap. If the axial length of the end cap is large, two or more sets of clamping slots and locking arms can be provided. If the axial length of the end cap is small, only one set of clamping slots and locking arms can be provided. But the width of the clamping slot in the axial direction and the width of the locking arm in the axial direction can be relatively large, so as to ensure that most of the contact surfaces between the part 1 and the part 2 can be tightly pressed together, so as to create reliable cohesion pressure on the fiber bundle.

As shown in FIG. 3, a positioning block 3 is provided on an end surface of the part 1 201 facing toward the part 2 202. Correspondingly, the end face of part 2 202 facing toward part 1 201 must be provided with positioning slot corresponding to the positioning block 3. When the part 1 and the part 2 are installed together, the positioning block 3 is inserted into the positioning slot to prevent relative sliding between the opposite sides of the two parts, and ensure that the free end of the locking arm is smoothly inserted into the corresponding clamping slot. Especially when there are multiple groups of clamping slots and locking arms, it is more necessary to set the positioning block and positioning slot.

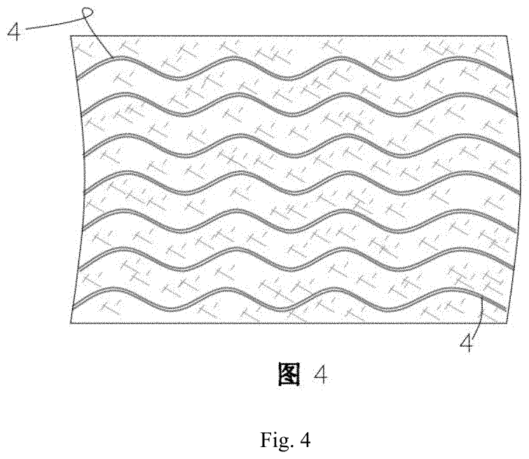

As shown in FIG. 4, in one embodiment, the (semi-cylindrical) wall of the pipe groove of part 1 201 and part 2 202 is provided with a plurality of ribs 4 distributed in axial phases.

The purpose of setting the ribs is to increase the resistance when the fiber bundle axially moves outward relative to the end cap, so as to ensure that the fiber bundle and the end cap are assembled into a tight integrated whole.

Because the part of the fiber bundle assembled into the joint segment 10B has a certain degree of elastic deformation capacity, the inner diameter of the hole formed after the part 1 and part 2 are relatively installed needs to be the same as the outer diameter of the joint segment 10B. The diameter is similar, preferably smaller (depending on the elastic deformation capacity of the joint segment).

The ribs can be used to force a relatively large deformation partially in the joint segment of the fiber bundle inside the cavity to increase the resistance that the fiber bundle needs to overcome when pulling out the end cap.

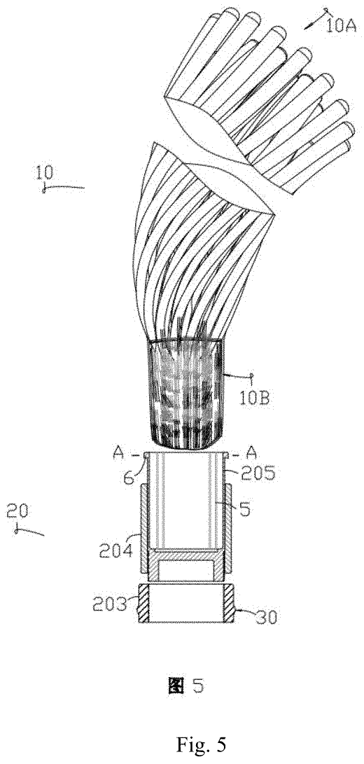

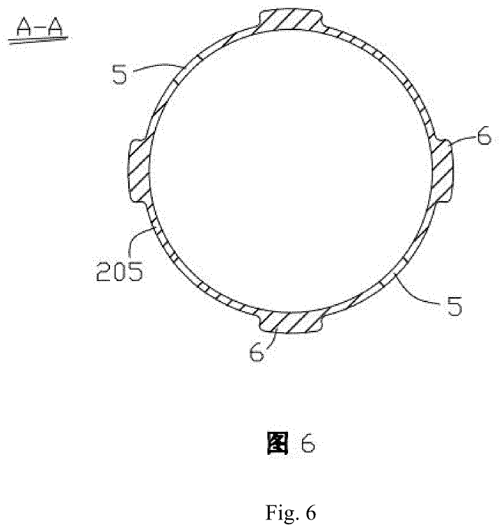

As shown in FIG. 5 and FIG. 6, the end cap comprises component 1 203, component 2 204 and component 3 205, wherein component 1 203 is a screw ring, component 2 204 is a sleeve, and component 3 205 is a cylinder, and the joint segment of fiber bundle 10 is arranged in the cylinder cavity of component 3 205.

The cylinder wall of the component 3 205 is provided with strip grooves 5 extending from the port toward the free end side. The number of the strip grooves 5 is four and they are distributed alternately around the cylinder wall.

An external thread section matching the component 1 203 is provided on the outer wall of the free end of the component 3 205.

The component 2 204 is sleeved on the outside of the component 3 205.

The axial length of component 3 205 is greater than the axial length of component 2 204. When the component 1 203 is gradually screwed on the external thread section of component 3 205, the component 1 203 can push the component 2 204 to move towards the cylinder cavity port direction of component 3. During this period, the inner wall of component 2 204 will squeeze the cylinder wall of the component 3 205 and gradually gather inward in the radial direction. Eventually, the joint segment 10B of fiber bundle 10 will be firmly controlled in the cylinder cavity of component 3 205.

The strip groove 5 provided on the wall of the cylinder cavity of the component 3 divides the wall into several parts. When the joint segment of the fiber bundle is inserted into the cylinder cavity of the component 3, each wall part of the component 3 can swing radially (with the help of plastic deformation), so that the size of the upper port of the cylinder cavity can be changed, and the resistance to the joint segment of fiber bundle when insertion will be greatly reduced. Therefore, the fiber bundle can be easily inserted into the hole of end cap.

The above structure can ensure that fiber bundle will not be easily detached from the component 3 or the end cap when it is continuously pulled by an external force.

The convex ring 30 is arranged on the outer wall of the component 1 203.

The wall thickness of component 3 205 is smaller than the wall thickness of component 2 204. Preferably, the wall thickness of component 3 205 is less than ½ of the wall thickness of component 2 204.

In order to ensure that the external shape of the whole connected by component 1 and the component 2 is suitable and easy to be installed on the object and firmly connected to the object, the external diameter of the component 2 204 should not be larger than the external diameter of the component 1.

Preferably, the convex points with curved/arc end surface are distributed on the outer wall of the cylinder cavity of the component 3, the component 2 is sleeved on the outside of the component 3, and the inner wall of the component 2 is in contact with the end surface of convex point on the external wall of the component 3. When component 2 moves relatively to component 3, the resistance experienced by component 2 can be reduced. In the initial state, the upper end of component 2 corresponds to the middle and lower part of component 3.

In one embodiment, the cylinder wall of component 3 is provided with strip bosses, the number of which is multiple and distributed around the cylinder wall. The strip boss extends along the axial direction and the side of facing inner wall of component 2 is a wedge surface, which gradually approaches the outer wall of the cylinder cavity of component 3 in the direction of free end (the free end in the fig.) from the cavity port of component 3 (the upper end in the fig).

The strip bosses may be arranged on one or both sides of the strip groove 5 or in the middle of the wall body between two adjacent strip grooves.

In one embodiment, the cavity port of the component 3 205 is provided with a flange 6 extending radially outward, which is composed of curved listrium arranged alternately around the outer wall of the component 3 205.

Correspondingly, one end face of component 2 204 is provided with a countersunk hole. When the end face moves to the flange 6, the flange can be stored in the countersunk hole.

It can make the entire component 3 205 basically be completely contained in component 1 203 and component 2 204. The notch formed by the strip groove at the cavity port of component 3 205 is stored inside the component 2, so that the end face of the end cap's cavity will be formed as a flat structure, avoiding the hooking impact of the corners/edges on the fiber bundles as much as possible.

In one embodiment, the cylinder port of the component 3 is provided with a flange extending radially inward, and the flange is composed of a plurality of arc listriums arranged around the inner wall of the component 3. By setting the arc listriums structure, when the component 2 causes the cavity port of the component 3 to be pushed inward, the arc listriums will be embedded in the joint segment of the fiber bundle, so that the component 3 and the fiber bundle can be better connected. In other words, a strong connection relationship is established between the end cap and the fiber bundle.

The extending direction of the upper arc listriums is opposite to that of the flange 6 shown in FIG. 6. Generally, the radial extension length is also smaller than that of the flange 6. The so-called arc listrium, that is, the radial free end face is an arc surface.

FIG. 7 to FIG. 9 show the structure and process of applying the decorative pellets involved to create an item or doll with a plush surface.

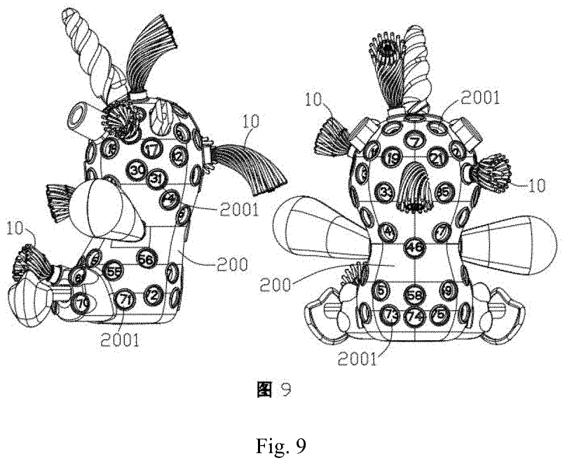

The implementation of the method needs to use the involved decorative pellets, and any of the above-mentioned decorative pellets can meet the requirements. At the same time, the implementation of this method also needs to provide a substrate with a fixed shape, such as the substrate-100 cake shown in FIG. 7, and the substrate-200 unicorn doll shown in FIG. 9; A plurality of holes 1001 are distributed on the substrate 100, and a plurality of holes 2001 are distributed on the substrate 200.

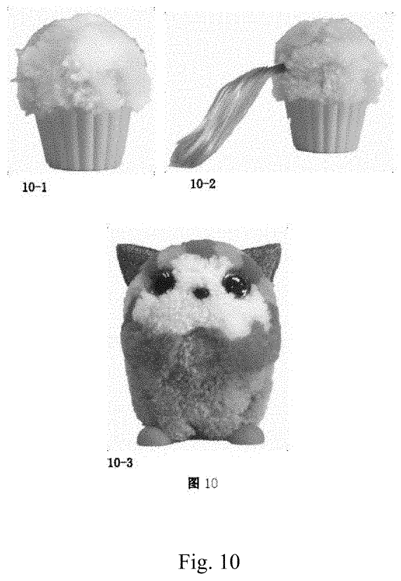

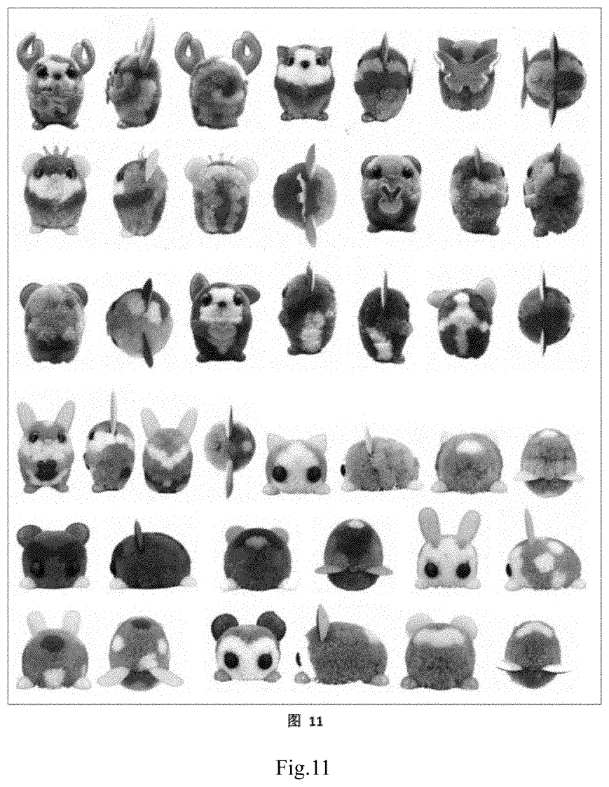

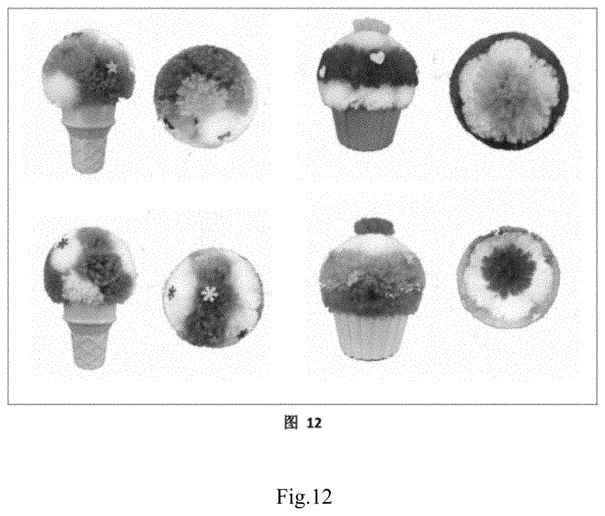

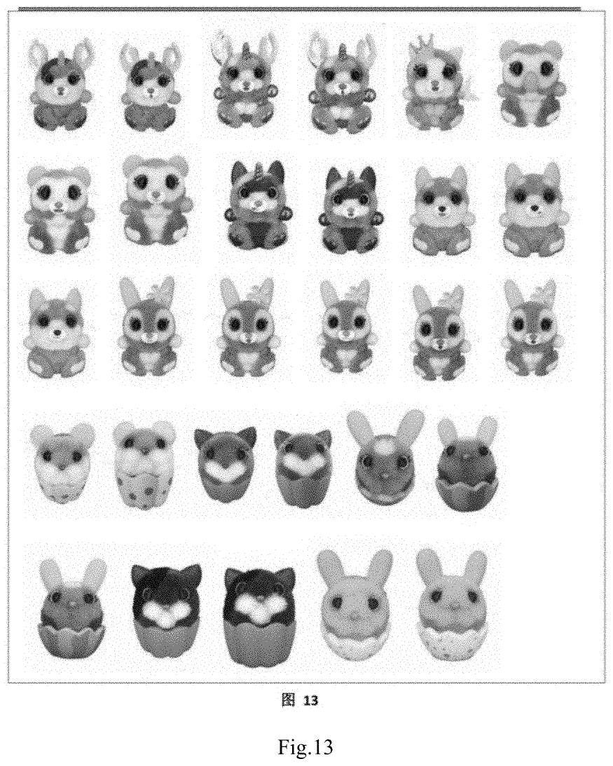

During the manufacturing process, the end cap of the decorative pellet is aligned with the hole/slot on the substrate and all the end caps are inserted into the hole/slot of the substrate. After the holes/slots on the substrate are all inserted by the decorative pellets, strongly press or distribute outward the fiber bundles of the decorative pellets so that the strands of the fiber bundles unfold and the surface of the substrate is covered to form a toy with a plush appearance (As shown in FIG. 10˜FIG. 13).

In a specific embodiment, the color of fiber bundles for most of decorative pellets is same, the color of fiber bundles for remaining decorative pellets can be different from the color of fiber bundles for most of decorative pellets, and the color of fiber bundles for remaining decorative pellets is same or is divided into a variety of color. The holes/slots on the substrate are marked with serial numbers (as shown in FIG. 7 to FIG. 10). According to the numbered range of holes/slots, the installation positions of decorative pellets with different colors are arranged regularly to form toys with multi-color combined plush surface and/or a certain pattern on the plush surface (As shown in FIG. 10˜FIG. 13).

The substrate 1 100 and substrate 2 200 can be made of plastic, plastomer (synthetic resin-polymer) and other materials that can form objects with a fixed shape. And metal materials can also be used in some embodiments. In even a few embodiments, plastic materials are mixed with metal materials. The materials of substrate 1 100 and substrate 2 200 can have a certain elasticity, but care that this should not affect the firmness of the connection between the substrate and the decorative pellets because of the elasticity of the substrate.

Above embodiments merely exemplify the principle of the present invention and its effect, and are not intended to limit the present invention. Many aspects of the present invention can be improved without violating the general idea. Those who are familiar with the technology can modify or change the above embodiments without departing from the spirit and scope of the present invention. Therefore, all equivalent modifications or changes made by those with ordinary knowledge in the technical field without departing from the spirit and technical ideas disclosed by the present invention should still be covered by the claims of the present invention.

We claim:

1. A decorative pellet, includes fiber bundle with one end in a free state and another end in an aggregated state, and an end cap which is at the end of the fiber bundle in an aggregated state. The aggregated end of the fiber bundle matches the end of the end cap. The fiber bundle contains a plurality of strands that are assembled at one end to be a joint segment and this joint segment is inserted into the endhole of the end cap. The surface of the strand is smooth and/or rough. The free end of the end cap can be plugged into the outside of the object and establish a tight assembly relationship with the object.

2. The method of claim 1, wherein the side wall of the end cap is provided with a convex ring or a plurality of convex points alternately distributed in a circle around the side wall of the end cap. The position of the convex ring or convex points is relatively close to the free end face of the end cap in the axial direction. An object used to bear the decorative pellet is provided with a hole/slot structure so as to match the end cap, and the convex ring or convex point will compress the inner wall of the hole/slot structure when the end cap is inserted into the hole/slot structure.

3. The method of claim 1, wherein the shape of the end cap is cylindrical or prismatic or conical.

4. The method of claim 1, wherein the end cap contains part 1 and part 2, and part 1 and part 2 are semi-cylindrical tubes installed oppositely, and the formed tube holes are cylindrical holes with the same inner diameter or conical holes that gradually become smaller from outside to inside.
On the side wall of part 1 and on both sides of the pipe notch, opposite clamping slots are arranged. Correspondingly, on the side wall of part 2 and on both sides of the pipe notch, locking arms corresponding to the clamping slots are arranged.
When the part 1 and part 2 are oppositely installed together, the free end of the locking arm is placed into the clamping slot, forming a clasping tension between the part 1 and the part 2, so that the opposite side of the part 1 and the part 2 is pressed together.

5. The method of claim 1, wherein the end cap comprises component 1, component 2 and component 3, wherein component 1 is a screw ring, component 2 is a sleeve, and component 3 is a cylinder. The wall thickness of component 3 is less than that of component 2.
The cylinder wall of the component 3 is provided with a strip groove extending from the port to the other end, and the number of the strip groove is multiple and alternately distributed around the cylinder wall. The outer wall of the other end of the component 3 is provided with an external thread section matching component 1. The component 2 is sleeved at the outside of component 3.
The axial length of component 3 is greater than the axial length of component 2. When the component 1 is gradually screwed on the external thread section of component 3, the component 1 can push the component 2 to move towards the cylinder cavity port direction of component 3. During this period, the inner wall of component 2 will squeeze the cylinder wall of the component 3 to gather inward in the radial direction gradually. Eventually, the joint segment of fiber bundle will be firmly controlled in the cylinder cavity of component 3.

6. The method of claim 5, wherein the end face is arranged as the convex point of the curved surface on the outer wall of the cavity of the component 3, and the inner wall of the component 2 can contact with the end face of the convex point on the outer wall of the component 3 when the component 2 is sleeved at the outside of component 3.

7. The method of claim 5, wherein the cylinder wall of component 3 is provided with strip bosses, the number of which is multiple and they are alternately distributed around the cylinder wall. The strip boss extends along the axial direction and the side of facing inner wall of components 2 is a wedge surface, which gradually approaches the outer wall of the cylinder cavity of component 3 in the direction of free end from the cavity port of component 3.

8. The method of claim 1, wherein the cavity port of component 3 is provided with a flange extending radially inward, and the reason for the flange is formed by a circle of arc listrium arranged in one circle around the inner wall of component 3.

9. The utility model relates to a method of using decorative pellets, which is the process of creating plush toys with a plurality of decorative pellets having the characteristics defined in claim 1. The implementation of the method also requires the provision of a fixed shape substrate with multiple holes/slots distributed on the surface of it. Characterized by: the end cap of the decorative pellets is aligned with the hole/slot on the substrate and all the end caps are inserted into the hole/slot of the substrate. After the holes/slots on the substrate are all inserted by the decorative pellets, strongly press or distribute outward the fiber bundles of the decorative pellets so that the strands of the fiber bundles unfold and the surface of the substrate is covered to form a toy with a plush appearance.

10. The method of claim 9, wherein the color of fiber bundles for most of decorative pellets is same, the color of fiber bundles for remaining decorative pellets can be different from the color of fiber bundles for most of decorative pellets, and the color of fiber bundles for remaining decorative pellets is the same or is divided into a variety of color. The holes/slots on the substrate are marked with serial numbers. According to the numbered range of holes/slots, the installation positions of decorative pellets with different colors are arranged regularly to form toys with multi-color combined plush surface and/or a certain pattern on the plush surface.
